(19) United States
(12) Patent Application Publication
(10) Pub. No.: US 2026/0349781 A1
(43) Pub. Date: Nov. 5, 2026

(54) AUTOMATED TASK OPTIMIZATION SYSTEM BASED ON EMERGENT BEHAVIOR

(71) Applicant: Damon Sauer, Lantana, FL (US)

(72) Inventor: Damon Sauer, Lantana, FL (US)

(21) Appl. No.: 19/636,132

(22) Filed: Apr. 1, 2026

Related U.S. Application Data
(60) Provisional application No. 63/792,310, filed on Apr. 22, 2025.

(51) Int. Cl. G06F 9/48; H04L 9/32

(52) U.S. Cl. CPC G06F 9/4843; H04L 9/3239

(57) ABSTRACT

A computer-implemented system and method for automatically optimizing human-machine interfaces (HMIs) across software applications, uses one or more processors to construct adaptive task graph data structures from timestamped operator interaction events, wherein nodes represent discrete interface states and directed edges carry multi-factor weights derived from runtime measurements of computational resource consumption including processor cycles, memory bandwidth utilization, and I/O operation costs captured via hardware performance counters. Graph analysis algorithms detect emergent behavior patterns such as operator-discovered workflows not present in baseline design models that achieve measurably lower traversal cost. An optimization engine evaluates a multi-objective cost function against measured hardware metrics to select optimized sequences that minimize actual computational resource consumption, validates modifications through controlled rollout with statistical confidence thresholds, and automatically deploys or rolls back changes. A three-layer safety architecture protects safety-critical functions.

### CROSS-REFERENCE TO RELATED APPLICATIONS

This application claims priority to U.S. Provisional Application Ser. No. 63/792,310 filed on Apr. 22, 2025, the contents of which are hereby incorporated in their entirety.

### STATEMENT REGARDING FEDERALLY SPONSORED RESEARCH OR DEVELOPMENT

Not Applicable.

### NAMES OF PARTIES TO A JOINT RESEARCH AGREEMENT

Not Applicable

### REFERENCE TO SEQUENCE LISTING, A TABLE, OR A COMPUTER PROGRAM LISTING APPENDIX SUBMITTED ON A COMPACT DISC AND INCORPORATION-BY-REFERENCE OF THE MATERIAL

Not Applicable.

### COPYRIGHT NOTICE

Not Applicable.

### BACKGROUND OF THE INVENTION

### Field of the Invention

The present invention relates to human-machine interface optimization. More particularly, the invention relates to a system that analyzes executable processes, detects emergent behavior, and optimizes an executable system to speed workflow times and minimize computations per workflow.

### Description of the Related Art

Human-machine interaction (HMI), sometimes also referred to as human-computer interaction (HCl), is the process through which people operate and engage with computer systems. As a field of research, HMI is situated at the intersection of computer science, behavioral sciences, design, media studies, and several other fields. Unlike other tools with specific and limited uses, computers have many uses which often require a dialogue between the user and the machine. The notion of dialogue likens human-computer interaction to human-to-human interaction: an analogy that is crucial to understanding the theoretical considerations in the field. Humans interact with computers in many ways, and the interface between the two is crucial to facilitating this interaction. This has led to a wide variety of interface types, which are continuously evolving.

Human-machine interfaces (HMIs) exist across virtually all modern technology domains. In software applications, users navigate through screens and menus. In industrial settings, operators interact with programmable logic controllers (PLCs) through human-machine interface panels. In aviation, pilots interact with multi-function displays (MFDs) in cockpits. In healthcare, medical professionals operate sophisticated equipment such as intravenous infusion pumps, cardiac monitors, and surgical control systems.

Poorly designed human-machine interfaces can lead to many unexpected problems. Poor interfaces have been identified as at least partially responsible for several accidents, including vehicle crashes, and even the Three Mile Island accident. Because of this, HMI has become a wide field of research, looking for ways to optimize human-computer interfaces to be more intuitive, natural, and easy to use effectively.

In the late 1980s and 1990, as computers became ubiquitous throughout every field and industry, they virtually all relied upon an interface consisting of a keyboard and monitor, i.e. a graphic user interface (GUI). A mouse was quickly added, and shortly thereafter most monitors switched to a “windows” format. These are still the most common tools for interacting with computers. Most development of HMI still focuses on optimizing the GUI by arranging modules in more clear and/or efficient ways.

Despite decades of research and development, a fundamental problem remains: interfaces are typically designed based on engineering assumptions about how they will be used, but operators often discover more efficient methods through practice. Current interface design relies on initial design phases, limited user testing, manual feedback collection, manual redesign, and slow iteration cycles over months or years.

This approach has several critical deficiencies. First, emergent behavior goes undetected—users collectively discover efficient workflows through trial and error, but these discoveries are not systematically captured and best practices remain known only to experienced operators. Second, domain-specific limitations exist across software applications (analytics tools only record sessions, A/B testing requires manual hypothesis), industrial PLCs (HMI interactions not analyzed systematically), aviation MFDs (pilot interactions not systematically analyzed), and medical devices (workarounds not captured or disseminated).

Third, no closed-loop optimization exists—all existing systems are descriptive (reporting what happened) rather than prescriptive (automatically improving the interface). Even when problems are identified, the redesign process is manual, slow, and relies on human intuition rather than data-driven optimization.

As a result, most optimizing of HMI's was slow. Problems are discovered slowly through complaints by users. The fixes require expensive manual redesign, and the improvements may take months or years to incorporate into an interface. In safety-critical systems, interface problems are often only discovered after incidents that can lead to serious harm. Changes to the interface usually require lengthy certification processes, and operators sometimes develop workarounds that aren't shared. Thus, the best practices stay locked in experienced operators' heads.

Currently there is no system capable of providing cross-domain application working across software, PLCs, MFDs, and medical devices; emergent behavior detection identifying when operators have discovered better methods; automatic optimization generation converting detected patterns into interface improvements; closed-loop implementation automatically deploying and validating optimizations; mathematical validation formally proving optimizations are improvements; and safety-critical support handling life-safety domains with appropriate validation.

The above-described deficiencies of today's systems are merely intended to provide an overview of some of the problems of conventional systems, and are not intended to be exhaustive. Other problems with the state of the art and corresponding benefits of some of the various non-limiting embodiments may become further apparent upon review of the following detailed description.

In view of the foregoing, it is desirable to provide an effective system of optimizing human-machine interactions by automatically modifying human-machine interfaces based on data collected from use of existing interfaces.

### BRIEF SUMMARY OF THE INVENTION

Disclosed is a system and method for automatically optimizing human-machine interfaces across diverse technological domains by observing actual operator behavior, detecting emergent usage patterns, and automatically implementing validated optimizations. The systems of the invention utilize Adaptive Task Graphs (ATGs) to model human-machine interactions consistently across diverse domains. For software applications, nodes represent screens/pages and edges represent navigation actions. For PLCs, nodes represent HMI panel states and edges represent operator control inputs. For MFDs, nodes represent display modes and edges represent pilot mode transitions. For medical devices, nodes represent device operational states and edges represent clinician actions. The system of the invention can thus be used to optimize any type of human-machine interface, regardless of industry, setting or purpose.

The system is used to detect when operators have collectively discovered workflows more efficient than the originally designed interfaces, including cycle detection (operators repeatedly toggle between states indicating need for unified view), shortcut discovery (operators use inefficient multi-step paths when better paths exist but are hidden), cluster formation (operators treat multiple interface states as single logical units), and temporal patterns (operators discover optimal timing patterns through collective experience).

In one embodiment, a computer-implemented method for automatically optimizing a human-machine interface (HMI) system includes receiving, by one or more processors, a plurality of timestamped interaction event records captured from operator interactions with an HMI system, each event record representing a distinct interface state, and comprising at least an event type, a source interface state identifier, a target interface state identifier, and a timestamp. A normalization process is executed on the event records that applies cryptographic hashing to user identifiers and filters noise events, thereby producing anonymized event data. A weighted adaptive task graph data structure is constructed from the anonymized event data stored in non-transitory computer memory, the adaptive task graph. The task graph includes a plurality of nodes, each node representing one of the distinct interface states of the HMI system and indexed by a cryptographic hash of state-defining attributes including an interface presentation identifier, an active element set, and an application context. A plurality of directed edges connect the nodes, each edge representing an observed operator transition between distinct interface states and weighted using a multi-objective cost function. One or more graph analysis algorithms are applied to the adaptive task graph data structure stored in the memory to identify at least one emergent behavior pattern. The emergent behavior patterns are identified from operator-discovered workflow paths between two distinct interface states. To be an emergent behavior pattern, the path must have been used by at least a predetermined minimum number of distinct operators independently, not be present in a stored baseline design model as an intended navigation path, have a traversal cost at least 5% less than a minimum traversal cost of any of the intended navigation paths of the stored baseline design model, and exhibit a p-value below a predetermined statistical significance threshold.

A machine-readable optimization specification data object is then generated that defines modifications to the HMI system to provide a direct transition between two distinct interface states having a traversal cost at least 10% less than any intended navigation path of the baseline design model. The optimization specification is selected from a predefined transformation catalog and linked to specific nodes and edges in the adaptive task graph. The cost reduction is evaluated against a multi-objective cost function incorporating runtime measurements of computational resource consumption including processor cycles, memory utilization, and I/O operation costs captured via hardware performance counters. A validation process is performed by deploying the machine-readable optimization specification data object to a subset of HMI system instances, collecting performance metrics from the subset, and computing statistical confidence that the optimization reduces the multi-objective cost function relative to a control group, the statistical confidence compared against a configured validation confidence threshold. If statistical confidence for the data object exceeds a configured validation confidence threshold, automatically transmitting the optimization specification to additional HMI system instances to modify interface behavior; or responsive to detecting performance metric degradation exceeding a configured regression threshold, automatically reverting the HMI system instances to a prior stored interface configuration within a configured maximum rollback time period. The entire process operates as a closed-loop optimization system that continuously observes new operator interactions, incrementally updates the adaptive task graph data structure in the memory without full recomputation, re-evaluates emergent behavior patterns against current baselines, generates new optimization candidates, validates candidates via controlled rollout, and deploys validated optimizations, all without requiring human intervention between optimization cycles. This incremental updating provides a reduction in computational resource consumption compared to full graph recomputation as measured by hardware performance counters monitoring processor cycles and memory bandwidth utilization.

The multi-objective cost function may be based on one or more of a transition latency, a transition error rate, a processor cycle consumption, and a cognitive load value derived from the anonymized event data. Emergent behavior patterns may be identified by applying a cycle detection algorithm and a shortest-path comparison algorithm on the adaptive task graph data structure to identify operator-discovered shortcut paths stored as edge sequences that achieve a reduction in weighted path cost relative to designed paths stored in the baseline design model. The cycle detection identifies repeated state visitation patterns indicating need for interface consolidation, and wherein the shortest-path comparison identifies operator-discovered navigation routes not present in the baseline design model. To generate the machine-readable optimization specification data object, one or more interface modifications may be selected from the predefined transformation catalog, the predefined transformation catalog comprising: reordering controls by observed usage frequency rank, exposing a shortcut action for transitions exceeding a configurable frequency threshold, merging interface states connected by obligatory sequential transitions with transition probability exceeding a configured threshold, and rebalancing alert priorities based on operator acknowledgment latency and response patterns, each transformation tied to specific nodes and edges in the adaptive task graph with quantified predicted cost reduction. The validation process may include running a randomized controlled rollout across a statistically representative subset of operators, computing improvement using the multi-objective cost function that weights latency, error rate, and action count, enforcing a configured minimum statistical confidence level using two-tailed statistical hypothesis testing, and halting with rollback upon violation of safety or performance guardrails, wherein guardrails comprise domain-specific thresholds for maximum acceptable error rate increase, latency regression, and safety-critical event frequency.

For safety-critical domains including aviation, medical, and industrial applications, the invention uses methods for statistical validation ensuring optimizations are genuine improvements, confidence thresholds providing different automation levels, gradual rollout starting with small operator populations, automatic rollback reverting changes if performance degrades, and regulatory compliance generating validation documentation for FAA, FDA, and OSHA approval.

It is therefore an object of the invention to improve operator efficiency and reduce temporal and computational costs of software and/or systems being used by multiple operators in real time. These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a flowchart of computer-implemented method for automatically optimizing a human-machine interface (HMI) system in accordance with the principles of the invention;

FIG. 2 is another flowchart of computer-implemented method for automatically optimizing a human-machine interface (HMI) system in accordance with the principles of the invention.

### DETAILED DESCRIPTION

The invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The disclosed subject matter is described with reference to the drawings, wherein like reference numerals are used to refer to like elements throughout. In the following description, for purposes of explanation, numerous specific details are set forth in order to provide a thorough understanding of the various embodiments of the subject disclosure. It may be evident, however, that the disclosed subject matter may be practiced without these specific details. In other instances, well-known structures and devices may be shown in block diagram form in order to facilitate describing the various embodiments herein.

Various embodiments of the disclosure could also include permutations of the various elements as if each dependent claim was a multiple dependent claim incorporating the limitations of each of the preceding dependent claims as well as the independent claims. Unless explicitly stated otherwise, such permutations are expressly within the scope of this disclosure. Similarly, the disclosure should be interpreted as including permutations of the various elements disclosed in the Figures, unless the various elements are clearly mutually exclusive.

Unless otherwise indicated, all numbers expressing quantities of ingredients, dimensions reaction conditions and so forth used in the specification and claims are to be understood as being modified in all instances by the term “about”. The term “a” or “an” as used herein means “at least one” unless specified otherwise. In this specification and the claims, the use of the singular includes the plural unless specifically stated otherwise. In addition, use of “or” means “and/or” unless stated otherwise. Moreover, the use of the term “including”, as well as other forms, such as “includes” and “included”, is not limiting. Also, terms such as “element” or “component” encompass both elements and components comprising one unit and elements and components that comprise more than one unit unless specifically stated otherwise.

For ease of understanding, the following definitions will apply throughout this description; however, no definition should be regarded as being superceding any art—accepted understanding of the listed terms.

“Adaptive Task Graph (ATG)” refers to a directed weighted graph data structure ATG=(V, E, W) stored in computer memory, where V is the set of discrete interface states (nodes), [symbol] V×V is the set of observed operator transitions (edges), and W: E→ [symbol] ⁺is a weight function assigning multi-factor cost values to each edge derived from runtime measurements of computational resource consumption. An ATG model represents how operators actually navigate a human-machine interface, as opposed to how designers intended the interface to be navigated.
“Human-Machine Interface (HMI)” refers to a system comprising one or more output modalities (including but not limited to visual displays, auditory outputs, haptic feedback devices, and neural stimulation interfaces), input modalities (including but not limited to touch, keyboard, mouse, voice, gesture, gaze-tracking, physiological signal, and direct neural input), and control elements through which a human operator or autonomous agent interacts with a computerized system to perform tasks. Examples include software application user interfaces, industrial programmable logic controller (PLC) control panels, aviation multi-function displays (MFDs), medical device control interfaces, embedded control system consoles, voice-only interfaces, ambient computing interfaces, and brain-computer interfaces.
“Graphical User Interface (GUI) / Interface Presentation State” refers to an individual interface state within an HMI presenting visual, auditory, haptic, or multi-modal elements through which operators input data, make selections, and receive feedback. As used herein, “GUI” encompasses any interface presentation modality including but not limited to visual displays, voice-driven interfaces, haptic feedback systems, brain-computer interface presentations, and hybrid multi-modal interfaces. Each HMI typically comprises multiple interface presentation states that operators navigate to perform tasks.
“Node (vertex)” refers to a discrete interface state in the ATG, identified by a cryptographic hash (such as SHA-256 or equivalent cryptographic hash algorithm) of state-defining attributes including interface presentation identifier, active element set, and application context. Each node represents a unique configuration of the HMI at a point during operator interaction.
“Edge” refers to a directed connection between two nodes in the ATG, representing an observed operator transition from one interface state to another. Each edge carries a weight computed from frequency, transition latency measured via hardware timing mechanisms, error rate, action count, cognitive-load proxy values, and hardware-measured resource consumption.
“Operator” refers to an entity that interacts with a human-machine interface to perform tasks. An operator may be a human user, a human operator assisted by automation, an autonomous software agent, an AI agent, a robotic system, or any combination thereof. The system observes and optimizes interaction patterns regardless of whether the operator is human, machine, or a human-machine team.
“Emergent behavior” refers to an operator-discovered workflow pattern that satisfies all of: (1) does not match any designed workflow in the baseline design model, (2) has frequency exceeding a configured statistical significance threshold, and (3) achieves measurably lower traversal cost as evaluated by the hardware-anchored multi-objective cost function. Emergent behaviors arise from operators collectively discovering more efficient methods than designers anticipated.
“Traversal cost” refers to the sum the edge weights for a particular path between two nodes. If the path requires traversing two edges, then the weights of those edges are added to generate the travel cost between the nodes for that particular path.
“Circuit Breaker” refers to a safety mechanism that prevents the system from touching dangerous functions.
“Circuit breaker architecture” refers to a multi-layer safety mechanism comprising exclusion zones, safety gates, and automatic rollback that prevents the optimization system from modifying safety-critical interface elements. The architecture ensures that optimization operates only within permitted boundaries.
“Exclusion zone” refers to interface elements permanently excluded from the optimization scope at the system configuration level, such that the optimization engine cannot generate, evaluate, or deploy modifications referencing these elements. Examples include weapons firing controls, emergency stop functions, medication dose confirmation displays, nuclear safety interlocks, and reactor protection system interfaces.
“Safety gate” refers to a domain-specific validation checkpoint that must be satisfied before an optimization affecting safety-relevant (but not excluded) interface elements can proceed to deployment. Safety gates include digital twin simulation with fault injection, regulatory compliance verification, formal methods analysis for highest criticality levels, and qualified human review.
“Rollback” refers to automatically reverting to the previous version if something goes wrong.
“Automatic rollback” refers to an automatic reversion of a deployed optimization to the prior versioned interface configuration, triggered when post-deployment monitoring detects performance metric degradation exceeding configured thresholds, completing within a configured maximum time period from degradation detection. “Optimization Specification” refers to a specific proposed change to fix a detected problem.
“A/B Test” refers to a comparison between two versions (original and changed) to scientifically measure which is better.
“Baseline” refers to the original performance before any changes.
“A/B test” (controlled experiment) refers to a randomized controlled experiment comparing interface configurations across statistically representative operator populations, using two-tailed statistical hypothesis testing to determine whether a modification produces measurable improvement in the cost function.
“Baseline design model” refers to a graph representation of intended workflows derived from a software's design specifications, used to classify observed patterns as emergent versus designed and to compute cost function improvements. The baseline design model includes all of the interface states, nodes of an ATG, and all of the model's transitions, i.e. edges of an ATG.
“Confidence threshold” refers to a configurable statistical significance level (e.g., p-value threshold) that must be satisfied before the system accepts that a measured improvement is genuine and not attributable to random variation. “Confidence Threshold” measures how sure the system must be (usually 95%) before accepting that an improvement is real.
“Cognitive-load proxies” refers to measures derived from hesitation time, error corrections, and input complexity; used as delta-weighted factors in edge costs.
“Safety margin” (sometimes denoted by an epsilon) refers to a configurable buffer applied in rollout decisions to avoid marginal or noisy improvements, ensuring that optimizations are meaningfully better than baselines rather than merely statistically significant.
“Optimization specification” refers to a structured, machine-readable data object tied to specific ATG nodes and edges that defines a proposed interface modification. Each specification is versioned, reversible, linked to the transformation catalog entry from which it was generated, and validated before deployment.
“Guarded rollout” refers staged deployment with configurable confidence levels, safety thresholds, and automatic rollback triggers tied to the cost function and domain KPIs.
“Privacy budget” refers to constraints applied during data collection (hashing, redaction, down-sampling, or differential-privacy noise) to prevent re-identification, with cumulative budget consumption tracked across rollouts using composition theorems.
“Federated aggregation” refers to a privacy-preserving method of constructing the adaptive task graph in distributed environments, wherein edge weights are computed locally on individual operator devices (edge computing devices) using locally-captured interaction events, and only aggregated edge-weight delta values are transmitted to a central aggregation server using secure aggregation cryptographic protocols. The central server mathematically aggregates the received deltas to construct a federated adaptive task graph without accessing raw interaction event data. This enables ATG construction across organizational boundaries while preserving operator privacy.
“Transformation catalog” refers to an extensible, predefined set of interface modification templates from which the optimization engine selects, including but not limited to: reordering controls by frequency rank, exposing shortcut actions, merging interface states connected by obligatory sequential transitions, rebalancing alert priorities, and additional domain-specific transformations as defined by system administrators. The catalog is designed to be extended with new transformation types as interface modalities and interaction paradigms evolve.
“Interaction event record” refers to a discrete data record capturing a single operator interaction with the HMI, comprising at minimum: an event type, a source interface state identifier identifying the interface state from which the interaction originated, a target interface state identifier identifying the interface state to which the interaction transitioned, and a high-precision timestamp. Additional fields may include anonymized session and user identifiers, action count, latency measurement, contextual data, and error indication.
“Source interface state identifier/Target interface state identifier” refers to identifiers within each interaction event record that specify the originating and destination interface states for an operator transition. These identifiers correspond to nodes in the adaptive task graph and are used to construct directed edges representing observed transitions.
“Constraint graph” refers to a data structure representing interlock rules as a graph specifying prohibited state combinations and required state sequences. Each proposed optimization is validated against the constraint graph prior to inclusion in the optimization specification, ensuring that safety-critical interlocks are preserved.
“Monotonically increasing version identifiers” refers to version numbers assigned to interface configurations that strictly increase with each new version, ensuring unambiguous ordering of configuration history and enabling reliable rollback to any prior version.
“Persistent audit store” refers to a durable, append-only data store to which audit data for each optimization decision is logged, comprising: timestamp of decision, adaptive task graph version, optimization specification content, validation metrics, deployment outcome, and a cryptographic hash linking each audit record to prior records for tamper evidence.
“Tamper evidence” refers to a property of the audit chain achieved by cryptographic hash linking, wherein each audit record includes a hash of the prior record, forming an immutable chain that enables detection of any unauthorized modification to the audit history.
“k-anonymity” refers to a privacy-preserving technique wherein state transitions observed by fewer than k distinct operators are suppressed or generalized before inclusion in the adaptive task graph, where k is a configurable minimum value. This prevents re-identification of individual operators from rare transition patterns.
“Differential privacy” refers to a mathematical privacy framework wherein calibrated noise is added to interaction counts or edge weights before graph construction. The noise magnitude is calibrated based on sensitivity computed as the maximum edge weight contribution per individual operator. Cumulative privacy budget consumption (epsilon) is tracked across rollouts using composition theorems, and rollouts are blocked when cumulative epsilon would exceed a configured maximum privacy budget. The Gaussian mechanism may be used to compute the noise, providing (epsilon, delta)-differential privacy guarantees.
“Gaussian mechanism” refers to a differential privacy mechanism that adds Gaussian-distributed noise calibrated to the sensitivity of the query and the desired privacy parameters (epsilon, delta), providing (epsilon, delta)-differential privacy guarantees for numerical queries on interaction data.
“One-way cryptographic hash function” refers to a hash function (such as SHA-256 or equivalent) that is computationally infeasible to invert, used for hashing user identifiers during normalization to prevent re-identification while enabling consistent aggregation.
“Stripping free-text fields” refers to a normalization step wherein free-form text input fields are removed from interaction event records before graph construction to prevent inclusion of personally identifiable information or sensitive data in the adaptive task graph.
“Debouncing” refers to a noise reduction technique applied during normalization wherein rapid duplicate events occurring within a configurable time window are collapsed into a single event, preventing inflated edge weights from repeated or spurious interaction signals.
“Secure multi-party computation” refers to a cryptographic protocol enabling multiple parties (edge computing devices) to jointly compute a function (aggregated edge weights) over their private inputs without revealing those inputs to each other or to the aggregation server.
“Threshold homomorphic encryption” refers to a cryptographic technique enabling computation on encrypted edge weight data, wherein decryption requires cooperation of a configurable threshold number of parties, used as an alternative secure aggregation method for federated adaptive task graph construction.
“Observation interface circuit” refers to a hardware circuit comprising input ports configured to receive and buffer HMI interaction telemetry data streams from connected human-machine interface systems. The circuit provides the physical interface between connected HMI systems and the optimization apparatus processors.
“Input ports/Output ports” refer to physical or logical communication interfaces on the optimization apparatus. Input ports receive HMI interaction telemetry data streams from connected systems. Output ports transmit optimization specification data and rollback commands to connected HMI systems.
“Hardware security module (HSM)” refers to a dedicated cryptographic processor or tamper-resistant hardware device used to apply cryptographic signatures to interface configuration packages, ensuring configuration integrity and authenticity. The HSM stores signing keys in a protected environment that resists extraction.
“Cryptographic signatures” refers to digital signatures applied to interface configuration packages using a hardware security module or equivalent cryptographic facility, ensuring that configuration packages have not been modified since signing and can be verified as originating from an authorized source.
“Digital twin simulation environment” refers to a software environment comprising executable code and data structures configured to replicate the operational behavior of a production HMI system, enabling testing of proposed optimization specifications without affecting production systems. The digital twin accepts captured operator workflow event sequences for replay, supports programmatic injection of synthetic load conditions and fault scenarios, and computes simulated safety and performance KPIs.
“Simulation engine” refers to a processing component comprising one or more processors configured to execute the digital twin simulation environment, performing workflow replay, fault injection, and KPI computation for proposed optimization specifications.
“Gatekeeper module” refers to a software module comprising processor-executable instructions that enforce safety and performance gates by comparing simulated KPIs against configured thresholds, blocking deployment of optimization specifications that would regress beyond acceptable limits, and transmitting automatic rollback commands when post-deployment metrics deviate from simulation baselines.
“Synthetic load” refers to artificially generated workload conditions injected into a digital twin simulation to test optimization specifications under stress, high-concurrency, and edge-case scenarios that may not be present in captured historical data.
“Clinician-in-the-loop simulation” refers to a validation approach for medical device optimizations wherein clinician operators participate in testing proposed interface modifications within a simulated environment, providing feedback on usability, safety, and clinical workflow impact before production deployment.
“Alarm-load analysis” refers to a validation metric for medical device interfaces that quantifies the change in alarm frequency, alarm fatigue indicators (such as repeated alarm acknowledgment without corrective action), and time-to-acknowledgment resulting from proposed interface optimizations.
“Safety instrumented system (SIS)” refers to a system composed of sensors, logic solvers, and final control elements designed to bring a process to a safe state when predetermined conditions are violated, as defined by IEC 61508 or successor standards. Optimization specifications are validated against SIS limits to ensure no proposed change affects safety-critical functions.
“Design Assurance Level (DAL)” refers to a classification (DAL-A through DAL-E under DO-178C or equivalent levels under successor standards) indicating the rigor of verification required for avionics software based on the severity of failure conditions. Optimizations affecting the highest-criticality levels (DAL-A or DAL-B) require additional verification including formal methods analysis.
“Human-readable rationale” refers to a structured, natural-language explanation included with each optimization specification that maps adaptive task graph changes to predicted cost reduction, enabling authorized reviewers to understand the basis for proposed modifications and approve or reject them with informed judgment.
“Baseline workflow drift” refers to a condition detected by monitoring shifts in node visit frequency distributions and edge weight distributions in the adaptive task graph over time. When drift exceeds a configured threshold, the system re-runs validation gates on previously-deployed optimizations to ensure they remain valid under changed usage patterns.

Disclosed is a system that monitors how an HMI is actually used and identifies inefficiencies in the interface design. The system then proposes and incorporates improvements into a limited number of interfaces to determine whether a proposed improvement resolves the issue. If so, the improvement is incorporated into all of the interfaces. Furthermore, any proposed changes to safety-critical functions may only be implemented upon approval by and adminstrator of the system. The system of the invention is capable of identifying and proposing solutions to situations where users discover that they can skip steps which were thought to be required by the HMI designers, fasters methods of processing data, data missing from some particular interfaces, and processes that frequently lead to mistakes or are bottlenecks.

This invention watches how people actually use computer interfaces, figures out when they've discovered better ways of doing things than the original designers intended, and automatically improves the interface for everyone. It's like having a system that notices when employees find shortcuts, tests whether those shortcuts actually work better, and then teaches those shortcuts to everyone else—all automatically. For dangerous systems like weapons or medical devices, the system includes “circuit breakers” that stop any changes before they can affect safety-critical functions.

How the System Identifies Mistakes in the Process. When engineers design a computer interface—whether it's a website, a factory control panel, or a cockpit display—they make their best guess about how people will use it. But once real people start using the system every day, they often discover that Some steps are unnecessary. Users find they can skip steps the designers thought were required. Some paths are inefficient. There's a faster way to get from A to B that the designers didn't anticipate. Some information is in the wrong place. Users keep flipping back and forth between screens because they need to see two things at once. Some sequences cause errors. A particular order of steps frequently leads to mistakes

The System Detects These Problems using a monitoring process. The system watches everything user do. The system records what buttons people click, what screens they visit, and how long they spend on each screen. It does not record personal information—it doesn't know who clicked, just that someone clicked. Think of it like a traffic counter on a highway that counts cars but doesn't record license plates.

Next, the system builds a map of how people actually work. From all this clicking data, the system builds a map, an “Adaptive Task Graph” that shows a) every screen or state the system can be in (these are dots/vertices on the map), b) Every path people take between screens (these are lines/edges connecting the dots/vertices), c) How often each path is used (thicker lines =more traffic, a/k/a weighting the graph), d) How long each path takes (longer times might indicate problems), and e) How often each path leads to errors (red flags).

The system knows what the designers intended users to do. It compares this “designed path” to what users actually do. When there's a big difference, that's a signal that something might be wrong—or that users have discovered something better. For example: A nurse programming a medication pump has to flip between the “Patient Info” screen and the “Dosage Calculator” screen 5-6 times because she needs to see the patient's weight while entering the dose. The system looks for “cycles” in the map—loops where users go A→B→A→B→A repeatedly. When these cycles happen frequently across many users, it's not user error—it's a design problem. Another example is where, in a factory control system, most operators click through 4 menus to adjust a setting. But veteran operators know they can hold Shift and double-click to jump directly there. New operators waste time because no one told them about the shortcut.

The system for optimizing an interface includes five interconnected modules that operate across all human-machine interface types:

### 1. the Observation Module.

This module captures an operator's interactions with an interface in real-time using domain-agnostic event logging of state changes, actions, timestamps, and outcomes. It preserves operator privacy through aggregation and PII removal, and is capable of handling high-frequency interactions, including the thousands of events per second found in some industrial settings. This module may include keyloggers and mousekey recorders. It typically also measures time spent at different points in an HMI. It may optionally also use eye tracking technology when an HMI includes a camera. Typically it keeps the users anonymous, only measuring the activity at the interface, not what individual person is performing the activity. The module also uses a sliding window for comparing events. Those skilled in the art will appreciate that sliding windows allow the module to more accurately identify similar or equivalent paths, costs and emergent behavior.

For example, when the optimization system of the invention is added to a computer system, it is programmed to monitor user interactions with a software program comprising an HMI that also being executed by the computer system. The optimization system identifies each individual GUI of the HMI, and measures the amount of time users spend on each GUI and determines the average amount of time spent on an individual GUI, minimum and maximum times spent, and standard deviations and/or variances for this time. The optimization system also measures the number of keystrokes, and the path taken by users from and to the GUI. Users will typically follow several different paths between different GUIs in the HMI. The optimization system will recognize each of these paths as a particular process.

### 2. The Adaptive Task Graphics (ATG) Generator Module

This module processes the captured interactions to create Adaptive Task Graphs. The graph identifies discrete interface states based on domain-specific criteria, creates weighted edges representing transition patterns, and normalizes graphs to remove noise and statistical outliers. For example, the ATG may be generated by treating every screen or state the system as a vertex, paths taken between screens or states are represented by edges connecting the vertices. The edges may be weighted by measuring how often each path is used (e.g. thicker edges may equate to more traffic), how long each path takes (longer times might indicate problems), and how often each path leads to errors (red flags).

The Pattern Detection Module applies various graph algorithms to detect emergent behaviors such as cycles, shortcuts, clusters, and temporal patterns. It then calculates statistical significance of detected patterns and filters false positives using multi-metric validation. Some of the more common possible patterns the system identifies may include:
Pattern 1: The Toggle Problem. This pattern consists of users repeatedly going back and forth between screens. This usually indicates that users need information from both screens at the same time, but they can only see one at a time. This results in unnecessary navigation and is inefficient and likely frustration for users. For example, if a nurse programming a medication pump toggles between a “Patient Info” screen and a “Dosage Calculator” screen 5-6 times because he or she needs to see the patient's weight while entering the dose. The Pattern Detection Module looks for “cycles” in the ATG map, i.e. loops where users go A→B→A→B→A repeatedly.
Pattern 2: The Hidden Shortcut Problem. This occurs when most users take a long path (A→B→C→D→E) to accomplish a task, but a few expert users take a short path (A→E directly). There means there already exists a faster way, but most users are unaware of it. The shortcut exists but is hidden or not obvious. For example, in a factory control system, most operators click through 4 menus to adjust a setting. But veteran operators know they can hold Shift and double-click to jump directly there. New operators waste time because no one told them about the shortcut. The Pattern Detection Module may identify these hidden shortcuts by calculating a “shortest possible path” between common starting points and destinations, then compares to the paths users actually take. When there's a big gap, the shortcut isn't discoverable enough.
Pattern 3: The Abandonment Problem. This occurs when users start a task, get partway through, then give up and start over or leave entirely. This is usually caused by something in the middle of the process is confusing, frustrating, or broken. For example, when users try to create a new account get to the “verify email” step, but 40% of them never complete it. This often indicates that the verification email is confusing or the link doesn't work well.
Pattern 4: The Error Hotspot Problem. When a particular screen or action has an unusually high error rate, this indicates that this portion of the HMI is confusing or misleading. For example, with a medical device, if 15% of users accidentally enter the dose in milligrams when the field expects micrograms, the HMI labeling may be unclear. The Pattern Detection Module may identify these situations by tracking error rates at each point in the system. When one point has errors far above the average, it's flagged as an “error hotspot” that needs attention.

To identify these and other patterns, the optimization system may utilize various algorithms, including sorting, shortest path (e.g. Dijkstra's and/or Johnson's algorithms), and gradient algorithms. The optimization system also determined probabilities for a user to travel from one GUI to another, and also detects patterns, or pathways along different GUIs to identify the most common user interactions. By identifying the various paths, the system can then identify long and short paths between GUIs to determine whether there is a shorter path that should be made available at one of the first GUIs in a given pathway.

In an exemplary embodiment, an Adaptive Task Graph ATG is a directed weighted graph ATG=(V, E, W) where V={v1, v2, . . . , vn} is the set of interface states (nodes), E is a subset of V x V representing the set of observed transitions (edges), and W: E->R+ is the weight function assigning cost to each edge. A cost function F(ATG) quantifies the expected computational and cognitive cost of operating the interface: F(ATG)=Sum of frequency(e) x cost(e) for all e in E, where cost(e)=alpha x latency(e)+beta x clicks(e)+gamma x errors(e)+delta x cognitive_load(e), and alpha, beta, gamma, delta are domain-specific weights. An optimization O is considered valid if and only if F(ATG_optimized)+epsilon<min(F(ATG_baseline)), where ATG_optimized is the graph after applying optimization, ATG_baseline is the set of baseline graphs (original designed workflows), and epsilon is a safety margin (typically 5% of baseline cost). A workflow pattern P is considered emergent (user-discovered rather than designed) if: P does not match any designed workflow in baseline set, P has frequency greater than 2 sigma above mean frequency (statistically significant), and F(P)<min(F(designed workflows))(measurably more efficient).

### 3. the Optimization Engine Module

This module generates domain-appropriate optimization proposals, applies mathematical cost function validation, prioritizes optimizations by expected impact, and produces implementation specifications for each domain. Different problems require different solutions. For example, when the Toggle Problem is identified, the system of the invention may create a split-screen view showing both A and B at once. If a Hidden Shortcut is identified, the system may add a visible button or menu item for the shortcut on one of the GUIs at or near the beginning of the path. If an Abandonment Point is detected, the system may simplify that step, add help text, or break it into smaller steps. If there is an Error Hotspot, the system may clarify labels, add validation, or change the default value. By including this module, the system doesn't just say “this is broken.” It says “this is broken, and here's exactly how to fix it, and here's the code change required.”

### 4. the Execution Module

This module implements the generated optimizations using domain-specific APIs, performs safety validation for critical systems, executes gradual rollout with statistical monitoring, and automatically rolls back unsuccessful optimizations. Proposed changes can include rearranging the layout of a particular GUI, adding navigation buttons to a GUI,

Before rolling out a fix to for the entire system, the system runs a controlled experiment. It splits the users into two groups: Group A (90%): Sees the original interface (control group), and Group B (10%): Sees the interface with the proposed fix (test group). The system then measures the results by monitoring and comparing both groups to determine whether Group B complete tasks faster, makes fewer errors, and/or abandons the process less often. In an exemplary embodiment, the system requires 95% confidence that the improvement is real, not random chance. This is measured over hundreds, preferably thousands, of iterations to ensure that enough users in both groups to be statistically valid.

Once a fix is determined to improve performance, it introduces the new interface gradually. For example, the system may introduce the new interface to 25% of users, and continue to monitor for any unexpected problems. It then expands to 50% of users, and continues to monitor. If there are no issues and the interface improves performance for this group, the system will introduce the new interface to 100% of users. At each stage, if problems appear, the system stops and may reverse course. This new interface is then continued to be monitored, just like the rest of the HMI. If the “fixed” version starts performing worse over time (maybe user behavior changed, or a new problem emerged), the system detects this and can alert human operators, automatically revert to the previous version, and/or propose a new fix.

### Safety Architecture.

The invention implements what is euphemistically referred to as a “circuit breaker” that prevents the optimization system from altering GUIs that involve sensitive processes. In one embodiment, this circuit breaker system has a three-layer safety architecture:

Layer 1 (Exclusion Zones) comprises interface elements completely excluded from optimization scope that are never analyzed and can never be modified by the system, including weapons firing controls, medication dose confirmations, nuclear safety interlocks, and emergency stop functions. These exclusion zones are defined at the code level. The user of the optimization system generally identifies which processes of a system may be excluded. The optimization system therefore cannot generate optimization proposals that reference these elements. Examples of Exclusion Zones include:

For weapons systems, firing buttons, arming switches, and target lock confirmations. These could cause unintended weapons discharge, and are therefore not available for modification by the optimization system.

For nuclear power systems, such SCRAM buttons, reactor control rod positions, and emergency shutdowns.

For medical devices, dose delivery confirmations, infusion start buttons, and defibrillator discharges.

For aviation, autopilot disengage, landing gear controls, and engine shutdown.

For industrial applications, emergency stop, safety interlock bypass, and pressure relief overrides.

Layer 2 (Safety Gates) comprises interface elements that can be analyzed but require human approval before any optimization is deployed, including critical process controls, safety-related displays, and regulatory compliance interfaces. For these elements, the system never automatically implements proposed fixes, but only notifies human users of the suggested fixes. Again, the user will identify which GUIs provide data that is relied upon by human users to make decisions.

Layer 3 (Automatic Rollback) provides continuous monitoring of key performance indicators with automatic reversion to prior configuration if metrics degrade beyond configured thresholds. Even for changes that pass all gates and get deployed, the system continuously monitors for problems. If certain thresholds are crossed, it automatically reverts to the previous version without waiting for human intervention. Exemplary rollback triggers that cause the optimization system to revert the monitored system to the original HMI design include error rate increases 10% above baseline, task completion time increases 15% above baseline, any safety incident occurring, user complaints spike 3× above normal, and system performance degradation such that response times are greater than twice has high.

### Examples of Safety Architecture

1. Military Defense System. When monitoring a military defense system HMI, the optimization system observes that users frequently toggle between the “Threat Assessment” screen and the “Asset Status” screen during missions. Thus, the optimization system proposes a split-screen view showing both simultaneously. Before this proposed fix can be implemented, it must be cleared by the “circuit breaker.” The user of the optimization system has identified three processes that the optimization system is precluded from altering: weapons release, targeting, and rules of engagement. The Threat Assessment and Asset Status screens do not control the weapons, targeting or weapons release processes, and so the fix passes the first safety layer. For the second safety gate, the proposed fix does involve the GUI for Threat Assessment, which displays information that human users rely on when making decisions. Therefore the proposed fix must be approved by a human before it can be implemented. If the human operators approve the change, then a limited rollout to 10% of operators is initiated. The optimization system then closely monitors the changes in speed and accuracy, as well as complaints, for the new split screen GUI. If no problems are detected after 7 days, then the fix is expanded, as explained above, and either fully incorporated into the system or discarded.

2. Medical Device (Infusion Pump). The operators of the optimization system allow it to optimize screen brightness based on ambient light, menu navigation order, the drug library search functionality, history display formatting, and alert sound volume (within safe range). The optimization system is programmed to exclude the “Start Infusion” button, dose confirmation dialog, rate change confirmation, drug concentration entry field, and Patient ID verification step.

The optimization system is programmed to allow modifications only upon human approval for alarm sound characteristics, default values for any field, workflow step ordering, and warning message texts.

And for the slightly-less-critical controls—the ones that aren't in the locked case but are still important—a human has to physically unlock them before any change can be made.

Software Application Embodiment: Client-side implementation includes web browsers with JavaScript instrumentation, mobile applications with native SDK instrumentation, and desktop applications with OS-level event hooks. Server-side implementation includes application servers, database servers for ATG storage, cache servers for real-time performance, message queues for event streaming, and computing clusters for distributed processing.

There are several types of computer software systems suitable for optimization in Accordance with the Invention. For example:

Industrial PLC: Edge devices include programmable logic controllers (Rockwell Allen-Bradley, Siemens S7, Schneider Modicon), HMI panels (touchscreen displays, button panels, SCADA interfaces), and data logging systems. Server infrastructure includes industrial servers hardened for factory environments with industrial Ethernet connectivity.

Aviation MFD: Certified avionics hardware includes multi-function displays (Honeywell Primus, Garmin G1000/G3000, Collins Aerospace Pro Line), flight management systems, data concentrators (ARINC 429, AFDX), with certification per DO-178C (software), DO-254 (hardware), and DO-160 (environmental). Ground-based processing uses secure server infrastructure for fleet-wide data analysis.

Medical Device: Medical-grade hardware includes embedded processors (ARM Cortex, Intel Atom medical-grade), IEC 60601-1 compliant touchscreens, FDA-cleared hardware platforms (Class II medical device classification), and FIPS 140-2 compliant data encryption for HIPAA. Backend infrastructure is HIPAA-compliant with encrypted storage and audit logging.

Military/Defense Command and Control: Hardware infrastructure includes ruggedized military-grade computing platforms (MIL-STD-810, MIL-STD-461), tactical displays and multi-function workstations, secure communications interfaces (Type 1 encryption, NSA-approved), and air-gapped processing environments. Optimization specifications are strictly limited to non-safety-critical interface elements and exclude weapons engagement authorization interfaces, firing controls, target designation for kinetic effects, rules of engagement decision gates, and safety interlock systems.

AI/LLM Conversational Interface: System architecture includes cloud-based LLM inference infrastructure, client applications, conversation session management, and multi-modal input processing. Emergent behavior detection identifies effective prompting structures, conversation scaffolding techniques, tool sequencing patterns, and context management strategies. Safety constraints preserve safety filters and content policies with human review gates for significant changes.

Oil and Gas Operations: Upstream drilling operations include drilling control systems, mud logging workstations, well control monitoring interfaces, and real-time data acquisition systems. Midstream pipeline operations include pipeline SCADA systems, compressor station controls, and leak detection systems. Downstream refinery operations include distributed control systems (DCS), advanced process control integration, and safety instrumented systems. Safety constraints assist in preserving control barriers, process safety limits, and environmental permit compliance.

Humanoid Robot and AI Agent Orchestration: Robot control interfaces include control workstations, sensor visualization displays, motion planning visualization, and fleet management dashboards. AI agent orchestration includes agent orchestration platforms, tool and API access management, execution monitoring dashboards, and human-in-the-loop approval gates. Safety constraints preserve emergency stop functionality, safety zone monitoring, and human-robot interaction protocols.

Fleet Management and Transportation: Hardware infrastructure includes fleet management platforms, electronic logging device interfaces, in-cab telematics and navigation systems, vehicle inspection terminals, and driver mobile applications. Safety constraints strictly preserve hours-of-service regulations (49 CFR Part 395), vehicle inspection requirements, and hazmat handling procedures. Regulatory compliance includes FMCSA regulations, DOT vehicle safety standards, and IFTA fuel tax reporting requirements.

Embedded Systems and IoT Implementation: The invention is implemented on resource-constrained embedded systems and Internet of Things (IoT) devices. Memory-constrained ATG representation uses compact graph encoding with fixed-point arithmetic, quantized edge weights (8-bit or 16-bit), and compressed node identifiers. Maximum graph size is configurable based on available RAM (typical: 1 KB-64 KB for microcontrollers, 64 KB-1 MB for embedded Linux).

Processing power adaptations include incremental graph updates rather than full recomputation, simplified pattern detection using lightweight heuristics, and batch processing during idle periods to minimize real-time CPU overhead. Target platforms include ARM Cortex-M series (M0, M3, M4, M7), ESP32, and similar microcontrollers. Power-aware operation includes event buffering to reduce transmission frequency, adaptive sampling rates based on battery level, and sleep-mode compatible event capture.

Edge-Cloud Split Architecture: For IoT deployments, the system implements a distributed architecture. Edge device responsibilities include real-time event capture with local buffering, lightweight event filtering and noise reduction, local privacy normalization (hashing, PII removal), compressed event transmission during connectivity windows, and local cache of most recent optimization configurations. Cloud infrastructure responsibilities include full ATG construction from aggregated edge data, complete pattern detection algorithm execution, optimization generation and validation, A/B test coordination across device fleet, and configuration distribution to edge devices.

Target platforms and applications include Industrial IoT (smart sensors, field devices, remote terminal units, edge gateways), Consumer IoT (smart home devices, wearables, connected appliances), Agricultural IoT (precision agriculture sensors, irrigation controllers, livestock monitors), Healthcare IoT (remote patient monitors, wearable health devices, point-of-care instruments), and Automotive Embedded (infotainment systems, telematics units, driver assistance interfaces).

Multi-User Coordination and Collaborative Optimization: The invention is applied to multi-user environments where multiple operators interact with shared interfaces or coordinated systems. Collaborative workflow detection includes handoff pattern detection identifying workflow transitions between operators (e.g., shift changes, role-based task routing), detecting inefficiencies in handoff procedures including information loss, redundant verification steps, and coordination delays.

Parallel work coordination tracks multiple operators working simultaneously on related tasks, identifies coordination overhead including waiting for others, duplicate work, and conflict resolution, and proposes workflow restructuring to minimize coordination costs. Team emergent behavior detection identifies team-level patterns where groups of operators collectively discover efficient coordination strategies.

Multi-Tenant ATG Architecture: For systems serving multiple organizations or user groups, the system maintains isolated ATGs. Tenant isolation provides separate ATG instances per tenant with cryptographic isolation and no cross-tenant data leakage. Shared learning with privacy enables optional federated learning across tenants without sharing raw data, with differential privacy applied to cross-tenant pattern aggregation. Role-based ATG views provide different ATG perspectives for different user roles within a tenant.

Conflict Resolution for Shared Interfaces: When optimizations affect interfaces used by multiple operators, change impact analysis identifies all operators and roles affected, quantifies potential disruption versus benefit, and flags high-impact changes for additional review. Staged rollout by user group deploys optimizations sequentially to user groups with automatic rollback if any group shows metric degradation. Preference reconciliation handles conflicting user group preferences through role-based configurations or unified designs.

Shift Handoff Optimization: For 24/7 operations, handoff workflow capture tracks information transfer between outgoing and incoming operators. Handoff efficiency detection identifies emergent handoff practices that improve continuity and surfaces patterns for standardization. Team performance analytics includes comparative team analysis, training gap detection identifying when new team members' patterns diverge from experienced operators, and workload distribution analysis detecting uneven distribution through ATG analysis.

### Example 1

The optimization system of the invention is applied to an email marketing application. Users use the marketing application to create new campaigns. The optimization system of the invention identified the different screens, i.e. individual GUIs and monitors the amount of time users spend on each GUI. It also monitors the sequences in which users travel between GUIs, how often different processes are completed, and the time taken to complete these processes. Processes are identified by the system by mapping the routes traveled by users through the various GUIs.

The optimization system learned that users visited 6 different screens, or GUIs, to complete setup. The data showed that the average completion time was 12 minutes, and had an error rate or 23% (users made mistakes requiring correction) and an abandonment rate of 18% (users gave up partway through).

In addition, the optimization system detected that users were toggling between “Audience” and “Content” screens repeatedly (toggle problem), frequently went back to fix the date and time on the “Schedule” screen (error hotspot), and most abandonments happened at the “Review” screen (too overwhelming). Thus the optimization system identified three of the problem patters described above. To resolve the toggle problem, the optimization system created an alternative GUI that combined the Audience and Content into a split-screen view. In addition, it created a modified Schedule screen with clearer timezone display (the field that was generating the most errors. Finally, the Review screen was modified to show only essential info, with “Show Details” option. It then introduced these changes to 10% of the users and compared user performance of these modifications to the performance using the original screens. The optimization system found that the completion time improved from 12 min to 7 min (42% faster), the error rate dropped from 23% to 8% (65% reduction), and the abandonment rate fell from 18% to 6% (67% reduction). Thus, the optimization system automatically deployed these fixes to all users after successful test.

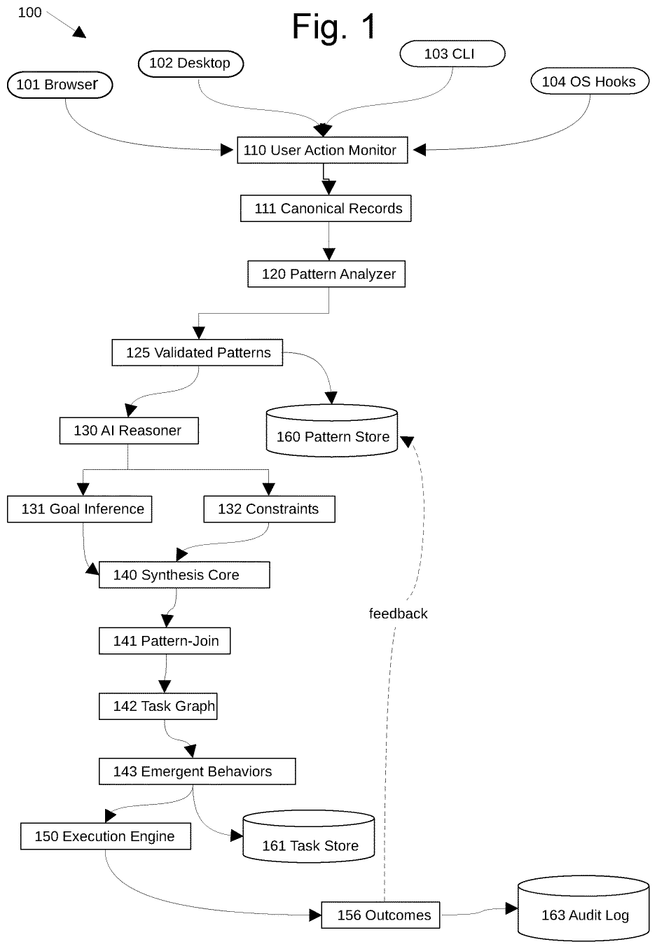

Referring to FIG. 1, a system 100 for adaptive task graph generation is shown. The high-level system architecture shows the end-to-end flow from operator interaction observation through optimization deployment. The system monitoring module 110 captures user actions which may include user initiated events occurring in a browser 101 or on a desktop computer 102. The module also captures events on a command line interface (CLI) 103 and also monitors any OS hooks 104. The user action monitor module captures events 101-104 by passively observing user interactions. The module also uses a computer system's canonical records 111 to accurately record the types of events monitored by the module 110. This information is sent to the pattern analyzer module 120.

The pattern analyzer module 120 identifies patterns in operator activity. Patterns identified by module 120 are validated 125, for example by applying a cost function to determine efficiency of a path (edges) between interface states. If the pattern is one that was generated and added to the system/software being monitored, the actual cost of the pattern is compared to the expected cost to evaluate the efficacy of the added pattern. Patterns and their costs are stored 160 and also sent to the AI reasoner module 130. Patterns detected in the computer operator's events are analyzed using AI 130 to infer goals 131 and identify constraints 132. The pattern analyzer then synthesizes 140 an ATG for the designated system or software being used by the operator, and joins the identified patterns together 141. The resulting ATG 142 matches activity patterns of the operator. The system then identifies emergent behaviors 143 in the patterns of operator behavior. Emergent behaviors, not part of the intended pathways/workflow of the system as designed, are scored to determine the traversal cost of an emergent behavior linking two distinct interface states. This traversal cost is then compared to the traversal costs of the designed, intended pathways. If the emergent behavior has a measurable cost advantage, then the system of the invention will generate an optimization fspecification data object, usually from a predetermined catalog of data objects, that adds the emergent behavior pathway to the system or software being used by the operator. This optimization specification data object is executed 150 and the pattern analyzer continues to monitor operator behaviors. If the added pathway improves efficiency, measured by traversal cost, then it is incorporated into the system. A new optimization specification data object may optionally be added only to a subgroup of operator's systems to first test the new feature before releasing it to additional operators.

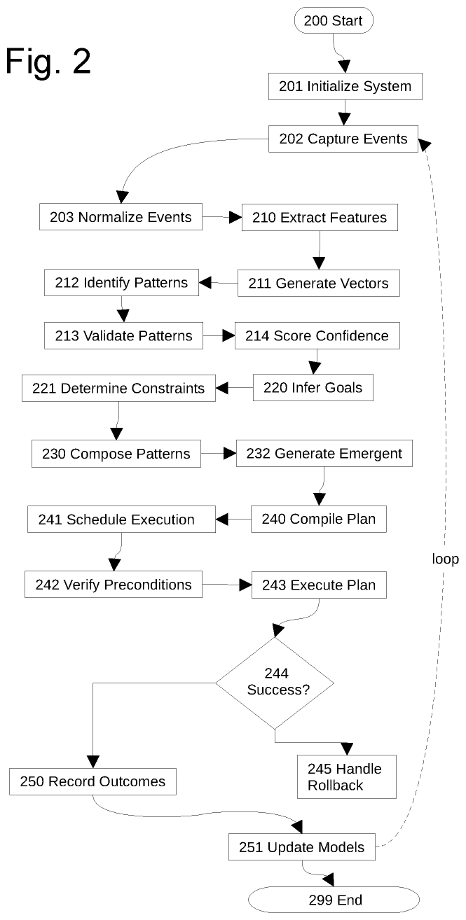

Referring to FIG. 2, the process begins at START 200. The system is initialized 201 and begins to capture operator events 202. These events are normalized 203 and used to extract features 210, specifically user behavior including events that traverse between interface states. These are used to generate vectors 211, an ATG is generated, and patterns are identified 212. Patterns are measured over time to confirm that they are used at least a predetermined minimum amount of times, and are scored 214 accordingly. The ATG is used to infer operator goals 220. This allows the constraints to be determined 221. Next, emergent behaviors are detected in the ATG patterns 230 and may be are used to optimize the ATG 231. Emergent behaviors are used to construct optimization specification data objects 232. These are compiled into a plan 240 to enhance the system being observed and used by the operator(s). Often a pre-existing catalog of objects is used to generate this new data object. Once generated, it is scheduled for execution 241, constraints and any preconditions are verified 242, and the data object is executed 243. If the addition to the system improves overall efficiency, again generally determined using a multi-objective cost function 244, the outcomes are recorded, and the model is updated 251. If the data object does not improve performance, it is rolled back 245. The process ends at END 299.

The system achieves performance improvements through multiple optimization techniques. Graph analysis identifies redundant paths that can be eliminated. Caching reduces repeated computations. Parallel execution leverages multiple processors. Emergent behavior manifests as self-organizing patterns within the adaptive task graphs. These patterns reveal optimization opportunities not apparent from individual interactions. The system operates transparently, requiring no user intervention. Optimizations are applied automatically while maintaining functional equivalence with original workflows. Validation ensures optimizations preserve correctness. The system maintains rollback capabilities to revert unsuccessful optimizations. Continuous learning improves optimization accuracy over time. The system adapts to changing usage patterns and interface modifications. Distributed architecture enables scalability. Edge processors capture local data while cloud resources perform complex analysis. Emergent behavior improves system performance by generating ATGs that reduce computational cost and latency in real-time UI automation when executed on hardware processors. The invention supports various computing environments including desktop applications, web interfaces, and mobile platforms. Integration with existing automation frameworks preserves prior investments while adding optimization capabilities. Privacy protection ensures sensitive user data remains secure. The system processes patterns without storing personal information. The adaptive task graphs evolve through iterative refinement, incorporating new patterns as they emerge from ongoing observations.

### Optimization Based on Runtime Cost Measurement

A computer-implemented method of the invention for automated task learning and execution may require massive computational processing on hardware processors with runtime measurement of computational efficiency. The method captures, using one or more hardware processors executing parallel event listener threads during runtime, interaction event data representing user interactions with a computing interfaces during normal user operations without requiring explicit recording or demonstration modes. The system simultaneously monitors multiple event channels including pointer events, keyboard events, DOM mutations, network packets, and process metrics. This may require parallel processing across multiple processor cores;

The system then generates one or more adaptive task graphs (ATG) representing observed interaction patterns, wherein the ATG comprises nodes representing user interface states and edges representing transitions between states with associated computational costs. To generate the ATG, the system may use one or more (i) graph mining algorithms with O(|V|³·|G|) computational complexity where V is vertices per graph and G is number of graphs, (ii) Hidden Markov Model Viterbi decoding with O(T·N²·K) operations where T is time steps, N is number of hidden states, and K is number of observation sessions, (iii) Dynamic Time Warping with O(n·m) complexity for sequence alignment, and/or (iv) graph isomorphism testing with O(V³) complexity using the VF2 algorithm. In some systems, these operations may require parallel execution across multiple processor cores and consume approximately 71% of total synthesis computational cost.

The system then performs multi-objective cost function evaluation requiring O(k·|E|·log|V|) processor operations where k is candidate paths, E is edges, and V is vertices, emergent behavior patterns within the ATG that indicate optimization opportunities for reducing computational resource consumption. The multi-objective cost function F may be of the form F=Σ(wᵢ·mᵢ) for i=1 to n, where wᵢ represents learned weight coefficients for each objective metric, mᵢ represents measured metrics including at least one computational efficiency metric selected from: processor cycle consumption per transition, memory bandwidth utilization, cache hit rates, cache miss penalties, instruction pipeline efficiency, branch misprediction rates, I/O operation counts, disk access latency, network bandwidth consumption, or total execution latency. The computational efficiency metrics are measured during runtime execution of candidate task sequences on hardware processors using hardware performance counters, operating system profiling interfaces, or application performance monitoring subsystems that capture actual resource consumption during task execution. Candidate task sequences derived from the emergent behavior patterns and measuring actual computational costs during execution may be generated as alternative pathways for incorporation into the system being monitored. Each state transition is measured with performance monitoring to capture processor cycles consumed, memory accesses performed, cache operations executed, and I/O operations initiated, aggregating measured costs across all transitions in each candidate path, computing the multi-objective cost function F for each candidate based on measured runtime costs rather than theoretical step counts. Traversal costs are generally measured using the values of multi-objective cost functions.

The system then selects an optimized task sequence that minimizes the multi-objective cost function F based on measured computational efficiency metrics. The optimized task sequence may achieve measurable reduction of at least 60% in at least one computational efficiency metric compared to baseline execution patterns, and wherein selection is based on actual measured resource consumption during hardware execution rather than abstract step counting. This may require about 2.1 billion processor operations for synthesis and may result in measurable computational efficiency improvements of 60-93% reduction in processor cycles, memory bandwidth consumption, or execution latency through runtime measurement and optimization of computational resource utilization on hardware processors. The system continuously updates the weight coefficients wᵢ through reinforcement learning based on execution feedback, such that the system learns which computational efficiency metrics are most critical for each domain through measured performance data.

A computer-implemented method of the invention optimizes user interface navigation through computationally intensive graph search algorithms with runtime measurement of computational costs. First, it detects baseline navigation paths from observed user interaction data captured by monitoring a plurality of actual user sessions. The system then executes one or more pattern recognition algorithms with O(n²) complexity across n observation sessions. The system also measures actual computational resource consumption during state transitions, with hardware performance monitoring to capture processor cycles consumed, memory accesses performed, cache operations executed, DOM rendering costs, JavaScript, execution time, network request latencies, and I/O operation counts, recording measurement data for each transition using hardware performance counters, browser profiling APIs, or operating system instrumentation, aggregating measured costs across all transitions in the baseline path. The system then constructs a proposed optimized model through graph-theoretic analysis requiring O(|V|²) operations for all-pairs shortest path computation. The optimized model identifies redundant computational operations within the baseline path, including unnecessary state transitions consuming measured processor cycles, duplicate data fetches causing measured memory bandwidth waste, redundant validation operations consuming measured I/O resources, inefficient DOM manipulations causing measured rendering overhead. Identification of inefficiencies is based on actual measured costs from hardware performance monitoring rather than theoretical step analysis. The system then generates one or more candidate optimized navigation sequences that eliminate identified redundant operations while maintaining functional equivalence. Each candidate navigation sequence are measuring for actual computational costs during execution using hardware instrumentation, and evaluating a multi-objective cost function F=Σ(wᵢ·mᵢ), where wᵢ are learned weight coefficients for each cost component, mᵢ are measured metrics including at least one computational efficiency metric, such as processor cycles per navigation, memory bandwidth consumed, cache miss rates, DOM rendering operations, JavaScript execution cycles, network bandwidth utilized, or total latency. The cost function uses actual measured values from runtime execution rather than theoretical estimates. The system then selects an optimized navigation sequence that minimizes the multi-objective cost function F based on measured computational efficiency metrics and executes it in response to user requests. Where the optimized sequence reduces computational resource consumption by at least 60% relative to the baseline, it is installed to replace the less efficient pathway.

In another embodiment, a computational system for discovering and implementing workflow optimizations utilizes parallel processing with runtime measurement of computational efficiency in hardware processors configured with parallel event capture threads to passively observe user interactions across multiple software interfaces simultaneously. The parallel capture generally performs best with multi-core execution to process event streams in real-time without event loss. A hardware performance monitoring subsystem integrated with the processors measures computational resource consumption during workflow execution. The system includes one or more forms of computer system performance monitoring, such as, for example, hardware performance counters for processor cycle measurement, memory bandwidth monitors for RAM access tracking, cache performance counters for hit/miss rate measurement, I/O instrumentation for disk and network operation cost measurement, and/or operating system profiling interfaces for process-level metrics. The system may be accelerated by including executable instructions for emergent pattern detection that may perform computationally intensive operations requiring billions processor operations including (i) graph mining with O(|V|³·|G|) complexity to identify inefficient patterns that users have normalized through repetition, (ii) statistical analysis with O(n·log n) complexity across n observed workflows to detect outliers and anomalies, (iii) graph isomorphism testing with O(V³) complexity to verify non-isomorphism of generated solutions, (iv) runtime measurement of actual computational costs during workflow execution using the hardware performance monitoring subsystem to capture processor cycles, memory bandwidth, cache efficiency, and I/O costs for each workflow step. The system also includes an optimization engine that generates and executes candidate alternative workflows while measuring actual computational resource consumption during execution. The system measures efficiencies of workflows by evaluating a multi-objective cost function F=Σ(wᵢ·mᵢ), where wᵢ are adaptive weight coefficients learned through reinforcement learning based on domain-specific performance requirements, mᵢ are measured computational efficiency metrics selected from one or more of processor cycles consumed, memory bandwidth utilized, cache miss rates, instruction pipeline stalls, I/O operation counts, network latency, and/or total execution time. The system selects alternative workflows that minimize F based on measured costs, generates alternatives reducing computational overhead by for example, at least 60%, through (a) eliminating redundant operations that consume unnecessary measured processor cycles, (b) consolidating related tasks to improve measured cache locality and reduce measured memory bandwidth consumption, and (c) reordering operations for improved measured cache utilization through sequential access patterns. The system's optimization engine may execute multi-objective optimization algorithms with O(k·p) complexity across k candidates and p objectives, and make optimization decisions based on actual measured computational costs from hardware performance monitoring rather than theoretical step minimization. The system includes an execution module that automatically implements the optimized alternatives using cache-optimized graph traversal algorithms while maintaining rollback capabilities through transaction logging. The execution module continuously measures computational costs during production and execution of optimized modules. The system may include a feedback subsystem that collects measured performance data from production executions, updates weight coefficients wᵢ through reinforcement learning based on measured computational efficiency and success rates, and adapts the optimization model to prioritize metrics most critical for the specific domain based on measured execution feedback.

In another embodiment, the system identifies emergent patterns and/or emergent behavior using computational verification algorithms with runtime measurement of computational efficiency. The system may use graph isomorphism testing requiring O(V³) operations per comparison using the VF2 algorithm to verify non-isomorphism condition: ∀i: ATG [symbol] PGᵢ, where ATG is the automated task graph and PGᵢ are input pattern graphs. For example, one type of graph isomorphism testing (i) computes graph edit distance with O(V³) complexity using the Hungarian algorithm for bipartite matching, (ii) verifies structural differences through adjacency matrix comparison requiring O(V²) memory accesses, and (iii) statistically validates that structural differences are significant beyond measurement error. The system then executes the synthesized ATG and each input pattern graph PGᵢ on hardware processors while measuring actual computational resource consumption during execution. Resources consumption may be measured by instrumenting each workflow with hardware performance monitoring to capture processor cycles consumed, memory bandwidth utilized, cache hit/miss rates, I/O operation counts, and execution latency for each step, using hardware performance counters, memory monitors, cache performance counters, and high-resolution timers to capture actual resource consumption during task execution, and aggregating measured costs for the complete workflow execution. The system may also measure relative consumption between workflows by evaluating a multi-objective cost function F requiring O(k) operations across k objective metrics, where F=Σ(wᵢ·mᵢ) for i=1 to k, where wᵢ are learned weight coefficients optimized through gradient descent, mᵢ are measured computational efficiency metrics including at least one of processor cycles consumed per execution, memory bandwidth utilized, cache miss penalty costs, I/O operation overhead, network latency, or total execution time, wherein all metrics mᵢ are measured during actual runtime execution on hardware processors rather than theoretically estimated or abstractly counted. Computational efficiency conditions are verified through measured comparisons, for example, F(ATG)+ε<min(F(PG₁), F(PG₂), . . . , F(PGₙ)), where F(ATG) is computed from measured costs during ATG execution on hardware, F(PGᵢ) is computed from measured costs during pattern graph execution, ε represents an acceptable threshold margin (typically 2.0), and all cost values are based on actual hardware measurements not theoretical step counts. Successful verification of requires satisfying both conditions: (a) non-isomorphism: ATG structure differs from all input patterns, and (b) measured efficiency: F(ATG)<min(F(PGᵢ)) based on measured costs proves emergent behavior mathematically through runtime measurement, demonstrating that the system generates automation strategies requiring measurably fewer computational resources (processor cycles, memory bandwidth, cache operations, I/O operations, or execution time) than any demonstrated pattern, where all comparisons are based on actual measurements from hardware performance monitoring during execution rather than abstract step counting or theoretical cost estimation.

In another embodiment, identifying emergent behavior patterns involves executing computationally intensive algorithms with runtime measurement of computational efficiency including analyzing frequency distributions of edge traversals in the ATG requiring and O(|E|·log|E|) sorting operations across edge weights. Edge weights in this embodiment represent measured computational costs including processor cycles, memory bandwidth, cache efficiency, and I/O operations captured during actual execution of transitions on hardware processors. The system also detects cycles and redundant paths that increase measured computational overhead through depth-first search with O(|V|+|E|) complexity and cycle detection requiring O(|V|²) in dense graphs, wherein redundancy is identified based on measured resource consumption rather than abstract step counting. Shortcut opportunities are identified that maintain functional equivalence while reducing measured processor cycles through all-pairs shortest path computation with O(|V|³) Floyd-Warshall algorithm or O(|V|²·log|V|) Johnson's algorithm for sparse graphs. Path costs are based on measured computational efficiency metrics captured via hardware performance monitoring. The execution module runs candidate optimizations while measuring actual computational costs using hardware instrumentation to verify that identified shortcuts achieve measurable reductions in resource consumption.

In another embodiment, the system generates an adaptive task graph by executing a pattern-join operator with computational complexity distributed across five steps and incorporating runtime cost measurements. It begins with subgoal alignments requiring O(n²·|V|) operations across n pattern graphs with |V| vertices each, using dynamic programming to find optimal alignment. Optimized alignments are found by considering measured computational costs of transitions in addition to structural similarity. Next the system performs graph unions with edge reweighting requiring O(|E|·log|V|) operations using Fibonacci heap for priority queue operations during edge merging. Edge reweighting combines measured costs from multiple pattern graphs. For each merged edge the system computes weighted averages of measured processor cycles, memory bandwidth, cache efficiency, and I/O costs across all pattern graphs containing that transition. The weights are adjusted based on measurement confidence intervals and sample sizes from each pattern graph and measurement metadata (mean, variance, confidence interval) for each edge to enable cost-aware path selection. The system then performs pareto-optimal pruning requiring O(k·p) comparisons across k candidate paths and p objectives to eliminate dominated solutions. Objectives include measuring computational efficiency metrics such as processor cycle consumption (measured via hardware counters), memory bandwidth utilization (measured via memory monitors), cache efficiency (measured via cache performance counters), I/O operation costs (measured via I/O instrumentation), execution latency (measured via high-resolution timers). A path is dominated if another path is superior in all measured metrics, and pruning eliminates paths based on actual measured costs rather than theoretical step counts. The system also performs shortest path discovery requiring O(|E|·log|V|) operations using Dijkstra's algorithm with Fibonacci heap implementation, wherein path cost is computed as F=Σ(wᵢ·mᵢ) for all edges in a path, where wᵢ are learned weight coefficients and mᵢ are measured computational costs for each edge. The algorithm selects paths minimizing F based on actual measured resource consumption. Next, the system performs topological ordering requiring O(|V|+|E|) operations using depth-first search for dependency resolution, ensuring execution sequence respects both logical dependencies and measured computational cost optimization. This five-step synthesis process may require approximately 450 million processor operations (21% of total synthesis cost) and produces an ATG with measurably lower computational cost than any input pattern graph verified through runtime execution and measurement. The synthesis operations are parallelized across multiple processor cores for real-time performance. The resulting ATG incorporates measured computational costs in edge weights enabling cost-aware execution path selection that optimizes actual resource consumption rather than abstract step minimization.

In another embodiment, the method of the invention is applied to database migration workflows and achieves measurable improvements through runtime cost measurements. The system performing the method observes user interactions during manual database migration operations, and captures event sequences including database queries, data transformations, validation checks, and commit operations. For each observed workflow step, the system measures actual computational costs using database profiling interfaces and hardware performance monitoring. For example, the system may capture SQL query execution time and processor cycles consumed, memory allocated for result sets and intermediate computations, disk I/O operations for data retrieval and storage, network bandwidth for database communication, transaction lock contention and wait times. Next the system performing the method identifies suspected redundant operations based on measured costs, such as, for example, duplicate queries consuming measured processor cycles and I/O operations, unnecessary validation steps consuming measured database execution time, inefficient data transformations causing measured memory allocation overhead, and transaction boundaries causing measured lock contention. The system takes measurements using actual measured costs rather than abstract operation counting. The system then synthesizes an optimized ATG that eliminates redundant operations while maintaining data integrity. This optimization is guided by measuring computational costs through multi-objective cost function F=Σ(wᵢ·mᵢ), where metrics include measured query execution time, I/O costs, memory consumption, and transaction latency. Execution failures are detected through runtime monitoring and automatically modifying the ATG to incorporate deduplication logic based on measured failure patterns. Modifications are validated through measured performance improvements in subsequent executions. Optimized workflow are identified by measurable improvements such as, for example, 93% reduction in processor cycles (measured: 2.7M→180K cycles), 92% reduction in memory bandwidth (measured via memory monitors), 77% improvement in cache hit rates (measured: 18%→4% miss rate), and/or 92% reduction in network requests (measured: 145→12 HTTP calls). These improvements are measured and verified using hardware performance monitoring and database profiling during actual execution.

In another embodiment, method of the invention is applied to video editing software workflows and achieves measurable GPU/CPU efficiency improvements through runtime cost measurement. The system observes user interactions during manual video editing operations such as one or more of clip selection, effect application, rendering, and export processes. The system executes each workflow step while measuring actual computational costs using GPU profiling APIs and CPU performance monitoring. The system then measures and captures GPU utilization percentage and shader execution cycles, CPU cycles consumed for video decoding and encoding operations, memory bandwidth between CPU and GPU (PCIe transfers), disk I/O for video file access and temporary storage, and GPU memory allocation and texture cache efficiency. The system then identifies optimization opportunities by identifying and measuring costs such as redundant GPU context switches consuming measured processor overhead, inefficient memory transfer patterns causing measured PCIe bandwidth waste, serial effect application preventing measured GPU utilization optimization, and/or duplicate render operations consuming measured GPU cycles. Opportunities are identified based on actual measured GPU/CPU costs from profiling APIs. The system then synthesizes an optimized batch processing workflow that consolidates effects to minimize measured GPU context switches, optimizes memory transfers to reduce measured PCIe bandwidth consumption, parallelizes operations to maximize measured GPU utilization, eliminates redundant renders to reduce measured shader execution cycles.

The method performed by the system then evaluates proposed optimizations by executing the optimized workflow while measuring computational efficiency and evaluating multi-objective cost function F including measured metrics such as for example total GPU cycles consumed (measured via GPU profiling), CPU cycles for encode/decode (measured via CPU performance counters), memory bandwidth utilized (measured via PCIe monitors), and rendering latency (measured via GPU timers). An optimized workflow is considered an improvement to be installed into the system if it achieves measurable improvements such as for example, an 85% reduction in total execution time (measured: 17.25 →2.5 minutes), a 4% improvement in GPU utilization (measured: 92%→96% average), a 12% reduction in PCIe bandwidth consumption (measured via transfer monitors), or a 14% reduction in total operations (measured via GPU profiling). Improved performances are, as with other embodiments, verified through GPU and CPU performance monitoring during actual execution.

In another embodiment, method of the invention is applied to DevOps deployment pipelines and achieves measurable infrastructure efficiency improvements through runtime cost measurement. The system observes deployment workflows including build operations, test execution, containerization, and production rollout steps. The system performing the method measures actual computational costs using container runtime metrics and infrastructure monitoring, such as for example, CPU cycles consumed during build and test operations, memory allocated for container operations and test execution, disk I/O for image building and artifact storage, network bandwidth for image distribution and deployment, container startup latency and resource initialization costs. The system then identifies optimization opportunities based on measured costs, such as for example, redundant dependency installations consuming measured CPU and I/O, serial test execution preventing measured CPU utilization optimization, inefficient image layering causing measured storage and network overhead, and unnecessary build steps consuming measured processor cycles. An optimized pipeline is synthesized incorporating improvements such as caching dependencies to eliminate measured redundant I/O operations, parallelizing tests to maximize measured CPU utilization, optimizes image layers to reduce measured storage and network costs, eliminating unnecessary steps to reduce measured processor consumption. The optimized pipeline is executed while the system measures computational efficiency and evaluates cost function F that takes into account metrics such as total CPU cycles consumed (measured via container metrics), memory bandwidth utilized (measured via runtime monitors), disk I/O operations (measured via filesystem monitors), network bandwidth for image distribution (measured via network monitors), and end-to-end deployment latency (measured via pipeline timers). The system selects optimized pipelines by identifying the ones with predetermined measurable improvements such as for example 87% reduction in deployment time (measured: 4.5 hours→26 minutes), elimination of measured redundant operations (75% of original steps), improved resource utilization measured via infrastructure monitoring. The improvements are verified through container runtime metrics and infrastructure performance monitoring during actual deployments.

In another embodiment, method of the invention is applied to healthcare claims processing workflows and achieves measurable processing efficiency improvements through runtime cost measurement. The system observes claims processing workflows across 200 user sessions over 8 weeks, capturing 2.4 million events representing data entry, validation, code lookup, documentation review, and submission operations. It then executes a computational analysis, that may require approximately 2.1 billion processor operations, including event normalization requiring measured 50 million operations, extracts requiring measured 108 million operations, GSP mining which may require measured 6 million operations, HMM Viterbi decoding requiring measured 225 million operations, DTW comparisons requiring measured 480 million operations, and graph mining requiring measured 1.3 billion operations. The system measures actual computational costs during claims processing execution including measuring for example processor cycles consumed per claim processing workflow, memory bandwidth utilized for data access and validation, database query execution time and I/O costs, network latency for external system integration, total processing latency per claim. The system then identifies optimization opportunities based on measured costs, such as for example, redundant validation steps consuming measured processor cycles, duplicate database queries causing measured I/O overhead, inefficient code lookups consuming measured network bandwidth, and serial processing preventing measured CPU utilization optimization. The system then synthesizes an optimized claims processing workflow that minimizes multi-objective cost function F based on measured efficiency metrics. For example, where a baseline processing requires measured 15 minutes per claim with 180,000 processor cycles per claim, totaling 180 million cycles monthly for 1,000 claims. The system generates an optimized processing workflow that achieves a measured 4 minutes per claim with 45,000 processor cycles per claim (75% reduction), totaling 45 million cycles monthly (75% reduction), and measured annual savings of 1.62 billion processor cycles verified through hardware performance monitoring during actual claims processing operations.

In another embodiment, method of the invention is applied to manufacturing quality control workflows with real-time latency constraints and achieves measurable efficiency improvements through runtime cost measurement. The system first observes quality control inspection workflows including part measurement, defect detection, statistical analysis, and accept/reject decision operations. The system of the invention measures actual computational costs of each step using real-time performance monitoring, and captures processor cycles consumed per inspection operation, memory bandwidth for image processing and analysis, I/O costs for measurement device communication, computation latency for defect detection algorithms, total inspection cycle time. All measurements made by the system practicing the method of the invention operate under real-time constraint of <50 ms latency for production line integration. The system identifies optimization opportunities based on measured costs while maintaining real-time performance requirements, redundant image processing operations consuming measured processor cycles, inefficient measurement device polling causing measured I/O overhead, serial defect analysis preventing measured parallel processing optimization, and unnecessary statistical computations consuming measured CPU resources. The system then synthesizes an optimized inspection workflow that eliminates redundant operations to reduce measured processor consumption, parallelizes defect detection to maximize measured CPU utilization, optimizes device communication to minimize measured I/O latency, and streamlines statistical analysis to reduce measured computation time. As a result, the optimization solution maintains <50 ms latency constraint verified through measured execution timing. The system then executes the optimized workflow while measuring computational efficiency in real-time, evaluating cost function F including measured metrics under latency constraint. The real-time constraint of <50ms is physically impossible for human mental processes (human reaction time ~200 ms minimum), requiring hardware processor execution with measured performance monitoring. The optimized workflow achieves measurable improvements such as processor cycle reduction while maintaining <50 ms latency, improved throughput measured via inspection rate increase, reduced resource consumption measured via hardware monitoring, all verified through real-time performance measurement during actual production line operation.

In another embodiment, method of the invention is deployed on edge computing devices with constrained computational resources and it achieves measurable efficiency improvements through runtime cost measurement. The system begins by executing an ATG synthesis on resource-constrained edge processors with limited CPU, memory, and power budget. The system then measures actual computational costs during edge execution using lightweight performance monitoring adapted for constrained environments. To do this, the system measures and captures processor cycles consumed (critical for battery-powered devices), memory bandwidth utilized (limited by device capabilities), power consumption per operation (critical for energy efficiency), thermal impact of computations (critical for passive cooling). In this embodiment, measurements use low-overhead instrumentation suitable for edge deployment that are optimizing for edge-specific constraints through multi-objective cost function F including measured metrics, such as for example energy consumption per task execution (measured via power monitors), thermal generation from computation (measured via temperature sensors), memory footprint fitting within device limits (measured via allocators), processing latency within real-time constraints (measured via timers). The system then adapts ATG synthesis complexity based on measured device capabilities. It reduces pattern graph analysis depth for low-power devices, uses approximate algorithms when measured resources insufficient, offloads heavy computation to cloud when measured local capacity exceeded, and caching synthesis results to avoid measured redundant computation. The edge deployment achieves measurable benefits including for example reduced latency through local execution (measured via network elimination), improved privacy through data locality (no measured network transmission), continued operation during network outages (measured availability improvement), and lower cloud costs through edge processing (measured resource reduction). The system may continuously measure and optimize for edge-specific constraints including power consumption, thermal limits, memory capacity, and processing capabilities through runtime performance monitoring.

In another embodiment, the method of the invention includes additional steps performed by a computer system to achieve formal verification of synthesized ATG correctness with runtime cost measurement. The system monitors static verification of ATG properties prior to execution, verifies graph connectivity ensuring all states are reachable, validates topological ordering for dependency satisfaction, checks precondition/postcondition consistency, and proves termination guarantees through cycle analysis. Runtime verification during execution is measured by performing at least one of validating state transitions match expected ATG structure, verifying preconditions satisfied before operation execution, checking postconditions achieved after operation completion, monitoring invariant preservation throughout execution. The verification operations consume measured computational overhead quantified through performance monitoring. The system also evaluates verification overhead costs by measuring at least one of processor cycles consumed for precondition checking (measured per operation), memory bandwidth for state validation (measured via monitors), and execution latency added by verification (measured via timers). Overhead is optimized to balance correctness with efficiency. Computational efficiency properties are measured by formally verifying F(ATG)<min(F(PG₁), F(PG₂), . . . , F(PGₙ) ), proving non-isomorphism ∀i: ATG [symbol] PGᵢ through graph analysis, validating correctness preservation during optimization. These measured costs are taken from actual executions.

Whereas, the present invention has been described in relation to the drawings attached hereto, other and further modifications, apart from those shown or suggested herein, may be made within the spirit and scope of this invention. Those skilled in the art will appreciate that the conception, upon which this disclosure is based, may readily be utilized as a basis for the designing of other structures, methods and systems for carrying out the several purposes of the present invention. That is, the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. The descriptions of the embodiments shown in the drawings should not be construed as limiting or defining the ordinary and plain meanings of the terms of the claims unless such is explicitly indicated. The claims should be regarded as including such equivalent constructions insofar as they do not depart from the spirit and scope of the present invention.

1. A computer-implemented method for automatically optimizing a human-machine interface (HMI) system comprising:
(a) receiving, by one or more processors, a plurality of timestamped interaction event records captured from operator interactions with an HMI system, each event record representing a distinct interface state, and comprising at least an event type, a source interface state identifier, a target interface state identifier, and a timestamp;
(b) executing, by the one or more processors, a normalization process on the event records that applies cryptographic hashing to user identifiers and filters noise events, thereby producing anonymized event data;
(c) constructing from the anonymized event data, by the one or more processors, a weighted adaptive task graph data structure stored in non-transitory computer memory, the adaptive task graph comprising:
(i) a plurality of nodes, each node representing one of the distinct interface states of the HMI system and indexed by a cryptographic hash of state-defining attributes including an interface presentation identifier, an active element set, and an application context, and
(ii) a plurality of directed edges connecting the nodes, each edge representing an observed operator transition between distinct interface states and weighted using a multi-objective cost function;
(d) executing, by the one or more processors, one or more graph analysis algorithms on the adaptive task graph data structure stored in the memory to identify at least one emergent behavior pattern, wherein the emergent behavior pattern comprises an operator-discovered workflow path between two distinct interface states that:
(i) has been used by at least a predetermined minimum number of distinct operators independently;
(ii) is not present in a stored baseline design model as an intended navigation path,
(iii) has a traversal cost at least 10% less than a minimum traversal cost of any of the intended navigation paths of the stored baseline design model; and,
(iv) exhibits a p-value below a predetermined statistical significance threshold;
(e) generating, by the one or more processors, a machine-readable optimization specification data object that defines modifications to the HMI system to provide a direct transition between two distinct interface states having a traversal cost at least 10% less than any intended navigation path of the baseline design model;
wherein the optimization specification is selected from a predefined transformation catalog and linked to specific nodes and edges in the adaptive task graph, and wherein the cost reduction is evaluated against a multi-objective cost function incorporating runtime measurements of computational resource consumption including processor cycles, memory utilization, and I/O operation costs captured via hardware performance counters;
(f) executing, by the one or more processors, a validation process comprising deploying the machine-readable optimization specification data object to a subset of HMI system instances, collecting performance metrics from the subset, and computing statistical confidence that the optimization reduces the multi-objective cost function relative to a control group, the statistical confidence compared against a configured validation confidence threshold; and
(g) responsive to the statistical confidence exceeding the configured validation confidence threshold, automatically transmitting the optimization specification to additional HMI system instances to modify interface behavior; or responsive to detecting performance metric degradation exceeding a configured regression threshold, automatically reverting the HMI system instances to a prior stored interface configuration within a configured maximum rollback time period;
wherein the method operates as a closed-loop optimization system that continuously observes new operator interactions, incrementally updates the adaptive task graph data structure in the memory without full recomputation, re-evaluates emergent behavior patterns against current baselines, generates new optimization candidates, validates candidates via controlled rollout, and deploys validated optimizations, all without requiring human intervention between optimization cycles; and
wherein incremental updating achieves a reduction in computational resource consumption compared to full graph recomputation as measured by hardware performance counters monitoring processor cycles and memory bandwidth utilization.

2. The method of claim 1, wherein the multi-objective cost function is based on one or more of a transition latency, a transition error rate, a processor cycle consumption, and a cognitive load value derived from the anonymized event data.

3. The method of claim 2, wherein executing one or more graph analysis algorithms to identify emergent behavior patterns comprises executing, by the one or more processors, a cycle detection algorithm and a shortest-path comparison algorithm on the adaptive task graph data structure to identify operator-discovered shortcut paths stored as edge sequences that achieve a reduction in weighted path cost relative to designed paths stored in the baseline design model, wherein the cycle detection identifies repeated state visitation patterns indicating need for interface consolidation, and wherein the shortest-path comparison identifies operator-discovered navigation routes not present in the baseline design model.

4. The method of claim 3, wherein generating the machine-readable optimization specification data object comprises selecting interface modifications from the predefined transformation catalog, the predefined transformation catalog comprising: reordering controls by observed usage frequency rank, exposing a shortcut action for transitions exceeding a configurable frequency threshold, merging interface states connected by obligatory sequential transitions with transition probability exceeding a configured threshold, and rebalancing alert priorities based on operator acknowledgment latency and response patterns, each transformation tied to specific nodes and edges in the adaptive task graph with quantified predicted cost reduction.

5. The method of claim 4, wherein executing the validation process comprises running a randomized controlled rollout across a statistically representative subset of operators, computing improvement using the multi-objective cost function that weights latency, error rate, and action count, enforcing a configured minimum statistical confidence level using two-tailed statistical hypothesis testing, and halting with rollback upon violation of safety or performance guardrails, wherein guardrails comprise domain-specific thresholds for maximum acceptable error rate increase, latency regression, and safety-critical event frequency.
